(19) United States
(12) Patent Application Publication
(10) Pub. No.: US 2017/0091684 A1
(43) Pub. Date: Mar. 30, 2017

(54) Method for Planning and Assigning Productions

(71) Applicant: manroland web systems GmbH, Augsburg (DE)

(72) Inventors: Andreas Elchlepp, Aichach (DE); Gregor Enke, Augsburg (DE)

(73) Assignee: manroland web systems GmbH, Augsburg (DE)

(21) Appl. No.: 15/278,027

(22) Filed: Sep. 28, 2016

(30) Foreign Application Priority Data
Sep. 30, 2015 (DE) 10 2015 116 569.4

(51) Int. Cl. G06Q 10/06

(52) U.S. Cl. CPC G06Q 10/06312; G06Q 10/06313

(57) ABSTRACT

A method for a assigning at least one production order comprising known job data from one or a plurality of production orders, which are in line for processing, to a particular production device of a plurality of production devices, wherein production device data with regard to the production options thereof can be written to each of the production devices, by means of which an efficiency-optimized assignment of at least one production order to a particular production device is made possible without manual interventions and person-bound analysis. The method permits the assignment of the at least one production order to a particular production device with regard to at least one sorting criterion to be carried out automatically.

### CROSS-REFERENCE TO RELATED APPLICATION

This United States non-provisional utility patent application claims the benefit of priority to German Patent Application No. DE 10 2015 116 569.4 filed on Sep. 30, 2015, the entire contents of which are incorporated herein by reference.

### FIELD OF THE INVENTION

The invention relates to a method for planning and assigning at least one production order comprising known job data from one or a plurality of production orders, which are in line for processing, to a particular production device of a plurality of production devices, wherein production device data with regard to the production options thereof can be written to each of the production devices.

### BACKGROUND OF THE INVENTION

In companies comprising a plurality of production devices, such as printing presses or any other more or less complex production units, for example, the question always arises of distributing and making arrangements for the production orders to the different production devices in such a way that the production order is completed within the required timeframe on the one hand and that a utilization of the production devices, which is as even as possible, as well as a production of the products to be produced, which is as economical as possible, is ensured at the same time. Planned or unscheduled changes with regard to the availability or the production options of one or a plurality of the production devices can furthermore follow as well. A plurality of companies further also has production devices at different locations, which additionally complicates an efficiency-optimized planning and assignment of one or a plurality of production orders.

Even though different support options are already known from the prior art for roughly planning production capacities and production orders, such as the production of finished or partially completed printed products, for example, as is possible with so-called MIS systems, for example, such MIS systems can only ensure a capacity planning of the respectively integrated production systems, so that essentially only planned standstill times of the production devices, such as maintenance and cleaning intervals or production times, which result theoretically for processing a production order, for example, can be managed and also optimized, if necessary, with this. Due to the complex and diverse production options of production devices, such as web-fed or sheet-fed printing presses, for example, with the post-processing equipment connected downstream in combination with the diverse parameters of the product, which is to be produced, such as the format size of the finished printed product, the number of pages, the folding and collecting options, the use of sizing or sewing, etc., for example, the assignment of the respective production orders to particular production devices is still carried out according to the prior art by qualified personnel, so that the basis for the utilization and capacity planning, which is possible with the MIS systems, still depends on person-related decisions. In particular in the case of a plurality of available production devices of possibly the most diverse production methods and production parameters and/or the most diverse locations, a capacity limit as well as only a limited overview of the production devices, which are available on principle, is reached very quickly, when manually assigning the production orders to particular production devices.

A method for optimizing the production sequence is further known from DE 10 2014 114 731, but this method only teaches the optimization of the order of a plurality of production orders, which are assigned to a production device, with regard to at least one sorting criterion, wherein this plurality of production orders has already been assigned previously to only one production device.

A production planning and control system for printing presses is furthermore known from DE 10 2013 102 756 A1, by means of which an integration of printing form-variable printing presses into machinery of printing presses, which currently only has printing form-invariable technology, is possible. However, a comprehensive planning and assignment of print jobs is also not possible with this teaching.

### OBJECT AND SUMMARY OF THE INVENTION

The invention is thus based on the object of developing a method, by means of which an efficiency-optimized assignment of at least one production order to a particular production device is made possible without manual interventions and person-related analysis.

This object is solved by means of a method according to the present invention, as shown and described herein. The invention comprises a method, in the case of which the assignment of the at least one production order to a particular production device with regard to at least one sorting criterion is carried out automatically.

Such a method has the advantage that the one or the plurality of optimally suitable production devices, if required, are identified and selected by capturing and evaluating all relevant job data, which describe the product to be produced, as well as all relevant production device data, which specify the respective production options and parameters. The assignment of production orders to production devices is thus no longer dependent on the qualification and the wealth of experience of the respective controller, whose knowledge relating to the available machinery is furthermore finite and thus limited, whereby the preferences resulting in response to manual assignment due to the limitation of the information and thus suboptimal assignment of production orders to production devices, which can thus not be ruled out, is not necessary any longer.

The invention furthermore provides the advantage that a virtually unlimited number of parameters can be compared to each other in only one system due to the automatic evaluation, so that the current comparison of at least two separate systems—namely the knowledge of a controller relating to the production options of at least a part of the available machinery on the one hand and the comparison with the capacity planning of the respective machines, which is maintained manually or illustrated by means of an MIS system on the other hand, is no longer required, so that fewer interfaces and thus fewer sources of error as well as lower maintenance results.

Such an automated method of the invention at hand also provides the advantage that the manual assignment of the production devices, which is thus generated in a time-consuming manner, does not need to be adapted again in a highly time-consuming manner in response to changes, which are unforeseen or which are planned very quickly at short notice, of the availability or of the production options of at least one available production device, but that the modification of the production assignment can also occur automatically in this case and thus without additional capacity commitment.

The risk of a person-related error rate is further ruled out by means of the invention at hand, which provides for an effective, permanent and continuously high optimization of the machine assignment.

In an embodiment of the invention, the production method and/or the production options of each production device are stored in the production device data. For this purpose, it is not only possible to check the producibility of a production order by a production device, but to simultaneously determine the most economic production method, in particular with regard to the number of pages and the print run of the printed products, which are to be produced, in the exemplary case at hand the production of printed products, by considering different production methods, such as the offset, the intaglio printing or also digital printing form-variable printing methods, for example.

In a further embodiment of the invention, each data set of the production device data comprises a list of at least a part of all of the individual production options of this production device. Using the example of a web-fed printing press comprising a folder and post-processing equipment connected downstream, this is a list of all or of only a part of the printed products, for example, which can be produced on the printing press, for example divided according to the product sizes (width and height of the printed product), number of pages (for example 16-, 24-, 32-, 48-, 64- or 96-page products), folding options (for example broad sheet or tabloid products, top-folded products, cross-folded products, products produced by means of collect production). A plurality of data sets can thus be assigned to a production device via explicitly producible products, which has the advantage that the respective corresponding product and the characteristics thereof can be gathered from each data set.

Due to the fact, however, that only the production options of a corresponding production device, which are listed explicitly, are then stored in the case of this above-mentioned embodiment, only the productions of this production device, which are listed and named explicitly, can thus be assigned to this production device in the case of an automatic comparison of the job data of a production order to such explicit data sets of the production device data. If, for example, the data set for a production, which is possible on the production device, but which is not stored, is assigned, an automated comparison shows that this production cannot be carried out, even though it would in fact be possible. In a concrete example of a 64-page rotary offset printing press, this would mean that even though data sets for 48- and 64-page printed products are stored in the production device data, but no data set is stored for a 56-page product, an automatic comparison shows in this case that a 56-page printed product cannot be produced on this special 64-page printing press.

This is why a particularly advantageous embodiment of the invention shows that all individual production options of the corresponding production device can be deduced from the production device data. In this embodiment of the invention, the explicit production options are not stored for a production device, in fact, the corresponding production device data preferably comprise a configurable data set, in which the essential parameters, which comprise the respective reference values, such as maximum web width, maximum number of pages, folding options and the combinations thereof, options for sewing or sizing, if required as a function of the folding options or further post-processing options, for example, are stored, so that all of the production options can be calculated from this configurable data set and thus from the production device data, which are designed in this manner. Such an embodiment has the advantage that all of the production options can be deduced completely through this after a one-time creation of the configured data set, so that there is no risk to exclude production options by non-listing, even though they are actually possible on the corresponding production device.

In a further particularly advantageous embodiment of the invention, the job data is worded in a device-neutral or production device-neutral manner, respectively. This is completely different as compared to the current prior art, because when a production order, for example a print job of a production device, such as a rotary offset printing press, for example, is assigned according to the prior art, a production data set, which is explicitly valid only for the particular production device, is generated for carrying out the print job. If, for some reason, the same print job is shifted to a different printing press, which might even differ with reference to the parameters, a new, second data set must be generated again for this second printing press.

To avoid this effort in the future and to optimize a comparison of the job data to the production device data, the job data comprise production device-neutral parameters, which comprise the key data of the production order, so to speak. Using the example of a print job, these are the numbers of pages, data relating to format (height and width) of the printed product, information relating to the print substrate, the print run, information relating to sewing or sizing, information relating to the chromaticity and many more. The job data can thus be compared to the production device data of the most diverse production devices and can ultimately be assigned to a particular production device.

In a further particularly advantageous embodiment of the invention, the assignment of the production orders assigned to the particular production device is checked in response to the change of at least one parameter of the production device data of at least one relevant production device. If necessary, the assignment of the at least one production order to at least one particular production device is then corrected. In the exemplary case, this can mean that a production device fails in an unscheduled manner for a certain time period, for example. If the relevant parameter of the availability is either corrected manually or even automatically by means of the machine control, the production orders assigned in the failure period of this production device are determined automatically and are advantageously assigned to a different production device or to a plurality of other production devices, on which the relevant productions orders can also be produced, by repeated verification with the production device data of the remaining available production devices, but possibly by accepting various disadvantages, such as a suboptimal efficiency.

In this context, it is possible as a different case that at least one equipment feature of the particular production device is not functional, which, using the example of a web-fed printing press, can be the failure of a sewing apparatus, for example. In this case, the production orders assigned to the particular production device are searched once again according to the relevance of the sewing, only the print jobs, in the case of which in particular this sewing is required, are then checked with regard to the assignment to other suitable production devices, if required. As can be gathered from the examples, this provides for a very prompt and thus early reaction, if required, to unforeseen or unscheduled changes to the availability of production devices and thus commits significantly fewer resources and furthermore lowers the error risk as compared to the manual comparison of the relevant production orders.

In a further particularly advantageous embodiment of the invention, one production order is divided over a plurality of production devices, which are identical or which differ from one another, based on at least one parameter stored in the job data. Such a measure can be required or obvious, for example, if a high production volume must either be produced with only a short processing time, for example, so that this one production order is divided over a plurality of production devices, for the more or less simultaneous processing, for reasons of the capacity, which is to be processed at short notice, or the production order is to be sent to different delivery addresses in partial quantities, so that long and thus time-intensive or cost-intensive transport routes must also be considered in response to a central production.

Using the example of a print job, this can be a high print run of an advertising brochure, for example, which is produced in high print runs with a short waiting period and which is to be delivered to different distribution centers, which are relatively far apart from one another. It can be advantageous in this case to distribute this one print job onto a plurality of printing presses for an approximately simultaneous production, which printing presses are advantageously also distributed in such a way that short and/or cost-efficient transport routes to the delivery addresses can be ensured. This can have a significant advantage in particular in markets comprising a large geographic expansion.

In the case of this embodiment of the invention it is also possible for the partial production orders to be distributed to approximately identical production devices, such as identical web offset or web gravure printing presses, for example, or whether the partial production orders are distributed to production devices, which differ from one another, such as web-fed and sheet-fed printing presses, for example, or to printing form-invariable printing presses, such as offset or gravure printing presses and printing form-variable printing presses, such as inkjet printing presses or toner-based digital printing presses, for example. Depending on the parameters, in particular on the print run of the partial production orders, it can be advantageous to make arrangement for them on different production devices.

It is noted that the method according to the invention can be used for a plurality of different production devices, even though only particular examples based on printing presses are described herein.

### BRIEF DESCRIPTION OF THE DRAWING FIGURES

Exemplary embodiments of the invention are explained from the detailed description below. Without being limited thereto, the different exemplary embodiments are illustrated in greater detail by means of the accompanying drawing figures.

FIG. 1 shows a diagram of a job data management system according to the invention comprising a central management of the job data.

FIG. 2 shows a diagram of a job data management system according to the invention comprising an additional decentralized management of the job data.

### DETAILED DESCRIPTION OF EXEMPLARY EMBODIMENTS OF THE INVENTION

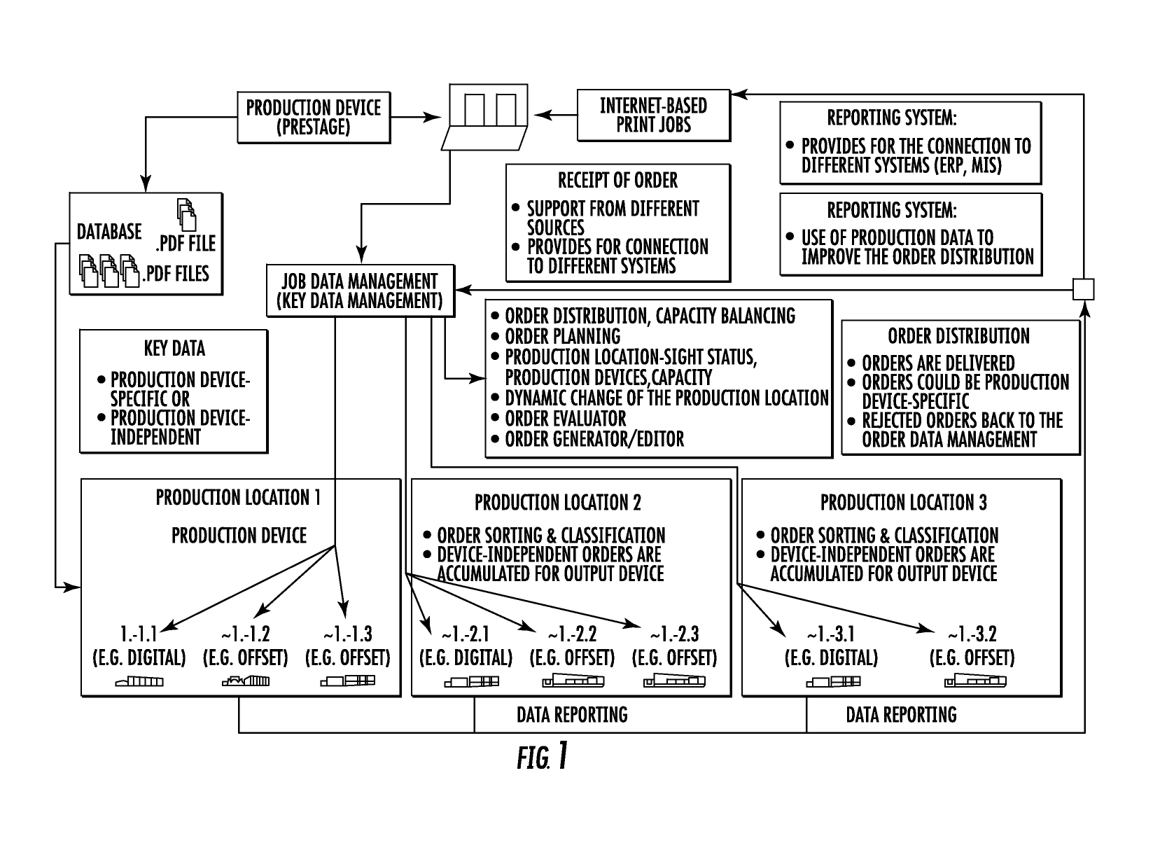

FIG. 1 shows a principle of the assignment of production orders with known job data from one or a plurality of production orders, which are in line for processing, to a particular production device of a plurality of production devices, wherein production device data with regard to the production options thereof can be written to each of the production devices, in a schematic manner.

New print jobs thus arrive at the control center of a print shop supplier, either via a pre-press system or via other sources, such as, for example, via the so-called Web2Print.

It is pointed out once again at this point that the method according to the invention can also be used for other production and manufacturing methods, such as, for example, the production of workpieces with or without cutting. However, to explain a particular application by means of the figures, this occurs by means of the production of printed products, such as magazines, catalogues, newspapers, flyers, etc.

The print jobs will be identified as production orders hereinafter, because the production of the print jobs represents a classical production method, which comprises at least one production step.

However, job data, which describe the characteristics of the corresponding printed product can be written to each of these production orders. When excluding the print contents, these job data could also be identified as key data of a printed product, because they comprise all of the essential parameters. For example, they are the dimensions of the printed product, the number of pages, the characteristics of the print substrate, the type of fold-over, the type of binding (binding, sewing, sizing, etc.), the print run, division into partial print runs, the delivery date, etc. This job data is preferably stored in a production device-neutral manner, that is, in a device-neutral format.

To produce the diverse production orders, the company, which is illustrated in an exemplary manner in FIG. 1, has a plurality of production devices, which are distributed to a plurality of production locations. At least one production device is present in each of these production locations in the form of different printing presses.

Each of these production devices has special and possibly specific production options, which are represented in the production device data. The production device data illustrate, how and which products can be produced by means of the respective production device. These are also data, such as the section length and product sizes to be produced, which result therefrom, maximum and minimum production speeds, the chromaticity, the different numbers of pages, which can be produced, folding options and other sizing, sewing and binding options. It is possible hereby that not only the printing press, such as a web-fed printing press including folder, for example, is considered to be the production device, but including all of the post-processing lines, such as binding machines, etc., which are connected downstream.

However, the production device data also comprise contents relating to the production methods, so that information relating to the respective printing method, for example, that is, whether the production device is an offset, gravure printing, a flexographic or a so-called digital, and thus printing form-variable printing press, such as inject printing devices or toner-based printing systems, for example, is also present in the production device data. The production device data can thus also comprise data relating to setup times, common waste figures, etc.

In a first embodiment of the individually possible productions, the production device data can be embodied in the form of a list, so that every possible production alternative is listed explicitly. However, due to the fact that such a list has the disadvantage that a production, which is not listed explicitly, can also not be considered in response to the selection, a solution is preferably used for illustrating the production options, in the case of which all production options of every production device are calculated and can thus be deduced from the production device data, which are incorporated in a matrix for each production device.

To simplify processing, for example, the production device data can simply be parameterized for this purpose with the help of a neutral data sheet, into which the parameters of the production device data is transferred.

According to the invention, the essential data is thus combined in the job data, thus the key data of a production order, which are preferably worded and set up in a production device-neutral manner, so as to be able to use them for all of the different production devices. All production options of each individual production device are known and can be read at the same time.

According to the invention, this assignment is thus carried out automatically with regard to at least one sorting criterion for the assignment of the at least one production order to at least one production device, in that the job data is compared automatically to the production options, which can be deduced from the production device data. This is possible by means of processing units using corresponding software.

It is thus possible with little effort to assign the possibly high number of the production orders, which are to be managed in the control center, to the individual production devices. FIG. 1 illustrates an alternative, in the case of which the assignment of the individual production orders occurs directly via the management system according to the invention for carrying out the method according to the invention from a control center to the individual production devices, which, in the example illustrated in FIG. 1, are distributed to three different production locations.

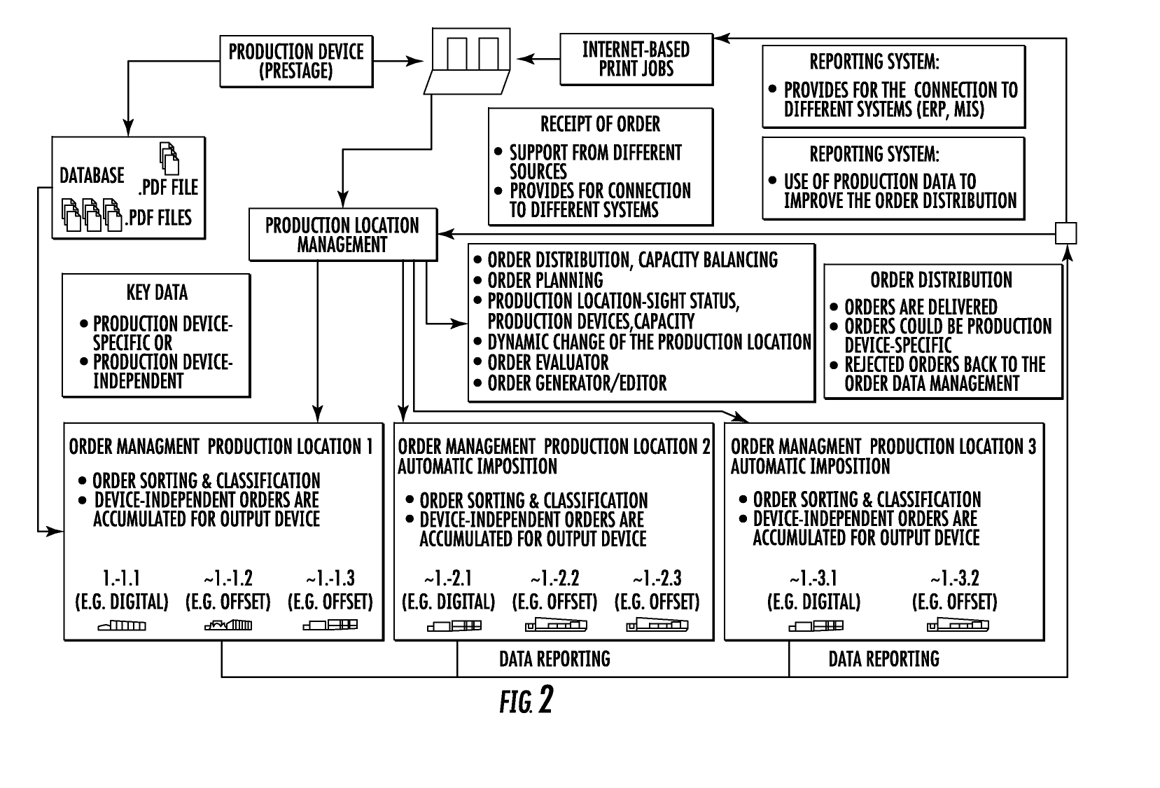

In contrast, FIG. 2 illustrates an alternative, in the case of which a distribution of the production orders occurs to the individual locations or already to the individual machines by automatically comparing the job data to the production device data, but the disposition to the individual production devices occurs decentralized by the management at the individual locations in the case of the alternative illustrated in FIG. 2. This is advantageous in particular, if a plurality of production devices comprising approximately the same production options are present at a location, so that the decentralized disposition needs to be essentially considered only via the utilization and the availability, for example, which can be advantageous in the case of a decentralized organization, in particular in the case of larger production locations.

The decentralized assignment of production orders to individual production devices can either occur via the software for carrying out the method according to the invention, but also via so-called MIS systems, which are connected by interfaces or which are self-sufficient, for the capacity planning, because essentially only purely capacitive aspect need to be considered.

According to the invention, it is possible in the alternative illustrated in FIG. 1 as well as in FIG. 2 that the assignment of the production orders assigned to the particular production device is checked again when changing at least one parameter of the production device data of a relevant production device. This can occur, for example, when a production device, such as a printing press, for example, or a post-processing or further processing component, which is required for the production order, fails for a certain period of time; in this case, the parameter of the availability of the corresponding production device would then change. It is a different case, for example, when a certain functionality of the printing press or of a further processing component, which is required for the corresponding production order, fails, such as, for example, a longitudinal sizing device, a stapler or a second cross folding, for example. All of the production orders, which were assigned to this production device, and which require this corresponding functionality, can possibly not be produced on the particular production device until this functionality is reestablished—at least if there is no other redundancy or substitution of this function within the production device. All of the production orders, which require the functionality, which is not available at least temporarily, can be determined very quickly in this regard by means of the automatism according to the invention by comparing the job data of the production orders, which are assigned to the production device, to the adapted production device data without manual intervention and thus for example with very high reliability, which does not depend on the qualification of the corresponding controller, and are assigned to other suitable production devices, so that the assignment of the at least one production order is corrected to at least one particular production device.

In the event that a production order has job data, which cannot be executed with one production step by means of the available production devices, because the discrepancy between the job data and the production device data is at least so large in one criterion that a plurality of production passes are required, the method according to the invention can also calculate the production of the production order in a plurality of partial production orders as a function of special parameters. This is the case, for example, when a 144-page printed product is to be produced, for example, but if all of the available printing presses only have a print capacity, which is smaller than the required number of pages. For example, only heatset units comprising a maximum capacity for the production of 96-page signatures are known at this time. Provided that the other parameters of the job data correspond to the production device data, such as product size, folding options, binding, etc., it can be calculated by means of the method according to the invention that the production order can be produced, when the production order is broken down into a plurality of partial production orders, wherein the partial products can be combined again to form the desired end product in an additional operating step. Based on the example of the 144-page product with an availability of a printing press for producing maximally 96-page printed products this means that the production order for producing the 144-page product is divided into a first partial production order comprising a 96-page signature and a second partial production order comprising a 48-page signature.

It is further also possible for a production order to be divided to a plurality of production devices, which are identical or which differ from one another. With reference to FIGS. 1 and 2 it is thus possible or even advantageous to divide a print job, which either has a very large print run, to a plurality of machines, in particular in response to short required processing times, so as to ensure a short processing time, for example, or a simplified distribution by means of short transport routes.

Depending on the respective partial production orders or the partial runs, for example, it can thus even be advantageous, if they are divided over production devices, which differ from one another. This can mean that the production devices, which differ from one another, only have a different size, production capacity or a different configuration. Based on the example of a print shop, this can mean that a print job, which is broken down into a plurality of partial runs, is produced at one location on a large-volume offset web-fed printing press, such as, for example, a 64-page printing system and on a small-volume offset web-fed printing press, such as a 16-page printing system, for example, at a different location, or possibly even by means of a sheet-fed offset printing press.

However, it is also possible for the production devices, which produce the respective partial production orders, to utilize production methods, which differ from one another. It can thus possibly be advantageous to print a high partial run on a web-fed or sheet-fed offset or gravure printing press—and thus on a printing press comprising a printing form-invariable printing method—and for a small partial run to be printed on a digital printing press and thus on a printing press comprising a printing form-variable printing method.

It is distinctive hereby, whether the production devices are distributed to a plurality of locations, or whether they are located only at one location.

1. A method for a assigning at least one production order comprising known job data from one or a plurality of production orders, which are in line for processing, to a particular production device of a plurality of production devices, wherein production device data with regard to the production options thereof can be written to each of the production devices, and wherein the assignment of the at least one production order to at least one particular production device with regard to at least one sorting criterion is carried out automatically.

2. The method according to claim 1, wherein the production options of each production device are stored in the production device data.

3. The method according to claim 2, wherein the production device data comprises all of the individual production options.

4. The method according to claim 2, wherein all of the production options can be deduced from the production device data.

5. The method according to claim 4, wherein the production device data is parameterized by a neutral data sheet.

6. The method according to claim 1, wherein the job data is worded in a production device-neutral manner.

7. The method according to claim 1, wherein the assignment of the production orders assigned to the particular production device is checked again when changing at least one parameter of the production device data of the relevant production device.

8. The method according to claim 7, wherein the assignment of the at least one production order is corrected to the particular production device.

9. The method according to claim 1, wherein a production order is divided over a plurality of production devices.

10. The method according to claim 9, wherein a production order is divided into a plurality of partial production orders, depending on the relation of the job data to the production device data.

11. The method according to claim 10, wherein the partial production orders are produced on one or more production devices.

12. The method according to claim 1, wherein production devices comprising different production options are utilized.

13. The method according to claim 1, wherein the production devices are distributed to a plurality of locations.

14. The method according to claim 1, wherein the production devices comprise printing devices.

15. The method according to claim 14, wherein at least one of the job data and the production device data comprise information relating to at least one of the product size, number of pages, print substrate, printing method, chromaticity, folding type, binding, production speeds, setup times, availabilities and standstill times.
